(19) United States
(12) Patent Application Publication
(10) Pub. No.: US 2015/0175473 A1
(43) Pub. Date: Jun. 25, 2015

(54) GLASS FOR CHEMICAL STRENGTHENING AND CHEMICAL STRENGTHENED GLASS

(71) Applicant: Asahi Glass Company, Limited, Tokyo (JP)

(72) Inventors: Hiroyuki YAMAMOTO, Shizuoka-ken (JP); Toshihiro TAKEUCHI, Tokyo (JP)

(73) Assignee: Asahi Glass Company, Limited, Tokyo (JP)

(21) Appl. No.: 14/634,015

(22) Filed: Feb. 27, 2015

Related U.S. Application Data
(63) Continuation of application No. PCT/JP2013/074493, filed on Sep. 11, 2013.

(30) Foreign Application Priority Data
Sep. 14, 2012 (JP) 2012-202728

(51) Int. Cl. C03C 3/091; C03C 4/18; C03C 3/087; C03C 21/00; C03C 3/085

(52) U.S. Cl. CPC C03C 3/091; C03C 21/002; C03C 3/085; C03C 3/087; C03C 4/18; C03C 2204/00

(57) ABSTRACT

A glass for chemical strengthening and a chemical strengthened glass each contains, in mole percentage based on following oxides, 55% to 80% of SiO₂, 3% to 16% of Al₂O₃, 0% to 12% of B₂O₃, 5% to 20% of Na₂O, 0% to 15% of K₂O, 0% to 15% of MgO, 0% to 3% of CaO, 0% to 18% of ΣRO (R represents Mg, Ca, Sr, Ba, Zn), 0.005% to 1% of SO₃, 0.001% to 3% of NiO, and 0.001% to 3% of CuO.

### CROSS-REFERENCE TO RELATED APPLICATIONS

This application is a continuation of prior International Application No. PCT/JP2013/074493, filed on Sep. 11, 2013 which is based upon and claims the benefit of priority from Japanese Patent Application No. 2012-202728 filed on Sep. 14, 2012; the entire contents of all of which are incorporated herein by reference.

### FIELD

The present invention relates to a glass for chemical strengthening and a chemical strengthened glass containing Ni (nickel) as a glass composition in which production of nickel sulfide (hereinafter, referred to as “NiS”) in glass is suppressed. In this specification, the “glass for chemical strengthening” means a glass before chemical strengthening, on a surface of which a compressive stress layer can be formed by the chemical strengthening. Further, the “chemical strengthened glass” means a glass treated by chemical strengthening, on a surface of which a compressive stress layer has been formed by the chemical strengthening.

### BACKGROUND

NiS existing in the glass is considered to be produced by binding of a Ni component that exfoliates from a glass manufacturing facility such as a stainless crusher or the like crushing a glass material and that mixes into the glass material and a S (sulfide) component of sodium sulfate (Na₂SO₄) or a sulfide material.

NiS, in a manufacturing process of glass or after being shipped as a product, gradually causes phase transition from α-NiS stable at high temperature to β-NiS stable at low temperature under a room temperature environment and, in this event, increases in volume by about 4% to cause occurrence of internal stress.

In particular, a heat strengthened plate glass to be used as a window glass for building or automobile is known to spontaneously break due to existence of NiS if NiS existing in the plate glass after strengthening has a grain diameter of 60 μm or more. More specifically, the heat strengthened plate glass has been strengthened by heating the plate glass close to a softening point and rapidly cooling it to make a compression stress remain on the plate glass surface and make tension stress remain inside the plate glass so that when another article comes into contact with the plate glass, the central tension stress occurring on the plate glass surface balances out with the compression stress remaining on the plate glass surface.

However, when NiS exists in the heat strengthened plate glass, small cracks possibly occur around NiS due to the above-described increase in volume of NiS and grow due to the remaining tension stress, resulting in spontaneous breakage.

Hence, heat treatment is conventionally performed (generally called “soak treatment”) in which the heat strengthened plate glass is heated again to 200° C. to 300° C. or lower and kept for a predetermined time and then slowly cooled. This soak treatment is taken as a measure to positively cause phase transition of α-NiS existing in the heat strengthened plate glass to β-NiS to thereby induce spontaneous breakage, and to ship only the heat strengthened plate glass not spontaneously broken by the soak treatment as a product.

However, the conventional method results in detection of the existence of NiS after the heat tempering is performed, leading to a significant decrease in manufacturing efficiency because of low yield of the heat strengthened plate glass.

Therefore, various methods and apparatuses have been conventionally proposed, such as a method and an apparatus of irradiating glass that is an object to be detected with a microwave, then measuring the temperature of the glass, and detecting the presence or absence of NiS existing in the glass on the basis of the change in measured temperature

### SUMMARY

However, using the above-described detection method of detecting the presence or absence of NiS existing in the glass causes a decrease in productivity of glass. Further, there is a need to thoroughly manage mixture of the NiS component from the glass manufacturing facility. Besides, a method of not using the Ni component in a raw material of glass is thought about, but if the Ni component cannot be intentionally used as the raw material of glass, there arises a constraint on color representation when coloring the glass.

An object of the present invention is to provide a glass for chemical strengthening and a chemical strengthened glass in which occurrence of NiS can be suppressed even if a Ni is contained in glass.

The present inventor found, as a result of various studies, that containing of a Cu (copper) component at a fixed amount in glass enabled suppression of production of NiS in the glass.

More specifically, a glass for chemical strengthening of the present invention contains, in mole percentage based on following oxides, 55% to 80% of SiO₂, 3% to 16% of Al₂O₃, 0% to 12% of B₂O₃, 5% to 20% of Na₂O, 0% to 15% of K₂O, 0% to 15% of MgO, 0% to 3% of CaO, 0% to 18% of ΣRO (R represents Mg, Ca, Sr, Ba, Zn), 0.005% to 1% of SO₃, 0.001% to 3% of NiO, and 0.001% to 3% of CuO.

Further, the glass for chemical strengthening of the present invention, contains 0.005% to 1% of SO₃, 0.01% to 3% of NiO, and 0.01% to 3% of CuO.

Further, in the glass for chemical strengthening of the present invention, both of an absolute value of a difference Δa* between chromaticity a* of reflected light by a Δ65 light source and chromaticity a* of reflected light by an F2 light source in an L*a*b* color system expressed by a following expression (1) and an absolute value of a difference Δb* between chromaticity b* of the reflected light by the D65 light source and chromaticity b* of the reflected light by the F2 light source in the L*a*b* color system expressed by a following expression (2), are 2.0 or less.

Δa*=a*value(D65 light source)−a*value(F2 light source) (1)

Δb*=b*value(D65 light source)−b*value(F2 light source) (2)

A chemical strengthened glass of the present invention contains: in mole percentage based on following oxides, 55% to 80% of SiO₂, 3% to 16% of Al₂O₃, 0% to 12% of B₂O₃, 5% to 20% of Na₂O, 0% to 15% of K₂O, 0% to 15% of MgO, 0% to 3% of CaO, 0% to 18% of ΣRO (R represents Mg, Ca, Sr, Ba, Zn), 0.005% to 1% of SO₃, 0.001% to 3% of NiO, and 0.001% to 3% of CuO; and has a surface compressive stress layer of 10 μm to 70 μm in a depth direction from a surface.

Further, the chemical strengthened glass of the present invention contains 0.005% to 1% of SO₃, 0.01% to 3% of NiO, and 0.01% to 3% of CuO.

Further, in the chemical strengthened glass of the present invention, both of an absolute value of a difference Δa* between chromaticity a* of reflected light by a D65 light source and chromaticity a* of reflected light by an F2 light source in an L*a*b* color system expressed by a following expression (1) and an absolute value of a difference Δb* between chromaticity b* of the reflected light by the D65 light source and chromaticity b* of the reflected light by the F2 light source in the L*a*b* color system expressed by a following expression (2), are 2.0 or less.

Δa*=a*value(D65 light source)−a*value(F2 light source) (1)

Δb*=b*value(D65 light source)−b*value(F2 light source) (2)

Further, the chemical strengthened glass of the present invention has a surface compressive stress of 300 MPa to 1400 MPa.

Further, in the chemical strengthened glass of the present invention, a central tension stress (CT) at a center in a plate thickness direction is 10 MPa or more.

Further, the chemical strengthened glass of the present invention is used as an exterior member.

According to the present invention, it is possible to obtain a glass for chemical strengthening and a chemical strengthened glass each made of a glass in which a Ni component is contained and occurrence of NiS is suppressed.

### DETAILED DESCRIPTION

As described above, normally, NiS in glass is produced in the glass by binding of the Ni component that mixes into the glass component due to the glass manufacturing facility and raw materials and the S component being a sulfide of the glass material during a melting process of the glass.

Therefore, the present inventor considered that the production of NiS could be suppressed by suppressing the reaction between the Ni component and the S component during melting of the glass.

The glass for chemical strengthening and the chemical strengthened glass of the present invention have been made by finding that the fact that the production of NiS can be suppressed by a Cu component contained together with the Ni component and the S component in the glass. The reason why the production of NiS can be suppressed is considered as follows.

In a later-described glass composition system, an equilibrium state between an oxide and a sulfide of Ni was studied by thermodynamic equilibrium calculation. Then, it was found that when the Ni component, the S component and the Cu component coexisted in a melting temperature range of the glass composition system, the glass became stable when the Ni component became an oxide and the Cu component became a sulfide in a thermodynamic calculation. This indicates that when the Cu component is melted together with the Ni component and the S component to form into glass, NiS is unlikely to be produced due to the existence of the Cu component.

Hereinafter, a composition of a glass of the present invention will be described using a content expressed in mole percent unless otherwise stated.

Note that in this specification, the content of each component of the glass indicates a converted content given that each component existing in the glass exists as the expressed represented oxide.
For example, “containing 0.001% to 3% of CuO” means a Cu content given that Cu existing in the glass exists entirely in the form of CuO, that is, the CuO-converted content of Cu is 0.001% to 3%.
As the glass of the present invention, one can be exemplified which contains in mole percentage based on following oxides, 55% to 80% of SiO₂, 3% to 16% of Al₂O₃, 0% to 12% of B₂O₃, 5% to 20% of Na₂O, 0% to 15% of K₂O, 0% to 15% of MgO, 0% to 3% of CaO, 0% to 18% of ΣRO (R represents Mg, Ca, Sr, Ba, Zn), 0.005% to 1% of SO₃, 0.001% to 3% of NiO, and 0.001% to 3% of CuO.

SiO₂ is a network former component of the glass and is essential. When its content is less than 55%, stability as a glass decreases, or weather resistance decreases. Preferably, its content is 60% or more. More preferably, its content is 65% or more. When the content of SiO₂ is more than 80%, viscosity of the glass increases, and meltability of the glass decreases significantly. Preferably, its content is 75% or less, typically 70% or less.

Al₂O₃ is a component improving weather resistance and chemical strengthening characteristic of the glass and is essential. When its content is less than 3%, the weather resistance decreases. Preferably, its content is 4% or more, typically 5% or more.

When the content of Al₂O₃ is more than 16%, viscosity of the glass becomes high and uniform melting becomes difficult. Preferably, its content is 14% or less, typically 12% or less.

B₂O₃ is a component improving weather resistance of the glass, and is not essential but can be contained as necessary. When B₂O₃ is contained, if its content is less than 4%, it is possible that a significant effect cannot be obtained regarding improvement of the weather resistance. Preferably, its content is 5% or more, typically 6% or more. When the content of B₂O₃ is more than 12%, it is possible that striae due to volatilization occur and the yield decreases. Preferably, its content is 11% or less, typically 10% or less.

Na₂O is a component improving meltability of the glass, and is essential because it causes a surface compressive stress layer to be formed by ion exchange. When its content is less than 5%, the meltability is poor and it is also difficult to form a desired surface compressive stress layer by ion exchange. Preferably, its content is 7% or more, typically 8% or more.

The weather resistance decreases when the content of Na₂O is more than 20%. Preferably, its content is 18% or less, typically 16% or less.

K₂O is a component improving meltability of the glass and having an operation to increase ion exchange speed in chemical strengthening. Thus, this component is not essential but is preferred to be contained. When K₂O is contained, if its content is less than 0.01%, it is possible that a significant effect cannot be obtained regarding improvement of meltability, or that a significant effect cannot be obtained regarding ion exchange speed improvement. Typically, its content is 0.3% or more. When the content of K₂O is more than 15%, weather resistance decreases. Preferably, its content is 12% or less, typically 10% or less.

RO (R represents Mg, Ca, Sr, Ba, Zn) is a component improving meltability of the glass and is not essential, but any one or more of them can be contained as necessary. In this case, it is possible that the meltability decreases when the total content ΣRO (ΣRO represents MgO+CaO+SrO+BaO+ZnO) of RO is less than 1%. Preferably, its content is 3% or more, typically 5% or more. When the total content of ΣRO is more than 18%, weather resistance decreases. Preferably, its content is 15% or less, more preferably 13% or less, typically 11% or less.

MgO is a component improving meltability of the glass, and is not essential but can be contained as necessary. When MgO is contained, if its content is less than 3%, it is possible that a significant effect cannot be obtained regarding improvement of meltability. Typically, its content is 4% or more. When the content of MgO is more than 15%, weather resistance decreases. Preferably, its content is 13% or less, typically 12% or less.

CaO is a component improving meltability of the glass and is not essential but can be contained as necessary. When CaO is contained, if its content is less than 0.01%, a significant effect cannot be obtained regarding improvement of meltability. Typically, its content is 0.1% or more. When the content of CaO is more than 3%, the chemical strengthening characteristic decreases. Preferably, its content is 2% or less, typically 1% or less. Further, in the case of increasing the chemical strengthening characteristic of the glass, practically, it is preferred not to be contained.

SrO is a component for improving meltability of the glass, and is not essential but can be contained as necessary. When SrO is contained, it is possible that a significant effect cannot be obtained regarding improvement of meltability if its content is less than 1%. Preferably, its content is 3% or more, typically 6% or more. When the content of SrO is more than 15%, it is possible that weather resistance and chemical strengthening characteristic decrease. Preferably, its content is 12% or less, typically 9% or less.

BaO is a component for improving meltability of the glass, and is not essential but can be contained as necessary. When BaO is contained, it is possible that a significant effect cannot be obtained regarding improvement of meltability if its content is less than 1%. Preferably, its content is 3% or more, typically 6% or more. When the content of BaO is more than 15%, it is possible that weather resistance and chemical strengthening characteristic decrease. Preferably, its content is 12% or less, typically 9% or less.

ZnO is a component for improving meltability of the glass, and is not essential but can be contained as necessary. When ZnO is contained, it is possible that a significant effect cannot be obtained regarding improvement of meltability if its content is less than 1%. Preferably, its content is 3% or more, typically 6% or more. When the content of ZnO is more than 15%, it is possible that weather resistance decreases. Preferably, its content is 12% or less, typically 9% or less.

ZrO₂ is a component increasing ion exchange speed and is not essential, but can be contained as necessary. When ZrO₂ is contained, its content is preferred in a range of 5% or less, more preferably in a range of 4% or less, even more preferably in a range of 3% or less. When the content of ZrO₂ is more than 5%, meltability worsens and it is possible that it remains as a non-melted matter in the glass. Typically, ZrO₂ is not contained.

SO₃ is a component operating as a refining agent, and is essential. When the content of SO₃ is less than 0.005%, an expected refining effect cannot be obtained. Preferably, its content is 0.01% or more, more preferably 0.02% or more. Most preferably, its content is 0.03% or more. Further, when its content is more than 1%, it inversely becomes a source of bubbles, and it is possible that melting down of the glass becomes slow or the number of bubbles increases. Preferably, its content is 0.8% or less, more preferably 0.6% or less. Most preferably, its content is 0.5% or less.

NiO is a coloring component for coloring a glass with a desired color tone and is essential. When its content is less than 0.001%, the desired color tone cannot be obtained. Preferably, its content is 0.005% or more, more preferably 0.01% or more. However, when it is contained in the glass, it is possible that metamerism occurs or a color tone change of the glass before and after chemical strengthening increases. Therefore, it is preferred that the content of NiO is 3% or less, more preferably 2.5% or less, even more preferably 2% or less. Further, when the glass is colored with a deep color tone, it is preferred that the content of NiO is 0.05% or more.

CuO is a component for suppressing production of NiS in the glass, and is essential. When its content is less than 0.001%, an effect to suppress the production of NiS cannot be sufficiently obtained. Preferably, its content is 0.005% or more, more preferably, 0.01% or more. However, when it is contained in large amount, the glass becomes unstable and devitrification may occur. Thus, the content of CuO is preferably 3% or less, more preferably 2.5% or less, even more preferably 2% or less. Further, when NiO is contained as a coloring component for the glass, it is possible that metamerism occurs. In contrast, when CuO is contained, metamerism can be suppressed. To suppress metamerism, it is preferred that the content of CuO is 0.03% or more.

In addition to the above components, the following components may be introduced in the glass composition.

SnO₂ is a component operating as a refining agent, and is not essential but can be contained as necessary. When SnO₂ is contained, an expected fining operation cannot be obtained if its content is less than 0.005%. Preferably, its content is 0.01% or more, more preferably 0.05% or more. Further, when its content is more than 1%, it inversely becomes a source of bubbles, and it is possible that melting down of the glass becomes slow or the number of bubbles increases. Preferably, its content is 0.8% or less, more preferably 0.5% or less. Most preferably, its content is 0.3% or less.

Li₂O is a component for improving meltability, and is not essential but can be contained as necessary. When Li₂O is contained, it is possible that a significant effect cannot be obtained regarding improvement of meltability if its content is less than 1%. Preferably, its content is 3% or more, typically 6% or more. When the content of Li₂O is more than 15%, it is possible that weather resistance decreases. Preferably, its content is 10% or less, typically 5% or less.

As the refining agent when melting the glass, chloride, fluoride and the like may be contained as necessary in addition to above-described SO₃, SnO₂.

As the coloring component, MpOq (where M represents at least one kind selected from among Fe, Ti, V, Cr, Pr, Ce, Bi, Eu, Mn, Er, Nd, W, Rb and Ag, and p and q represent atomic ratios of M and O) can be contained as necessary. The coloring components are components for coloring glass with a desired color. Appropriately selecting coloring components makes it possible to obtain a glass colored in, for example, blue, green, yellow, purple, pink, red, achromatic color or the like.

As described above, the glass for chemical strengthening and the chemical strengthened glass of the present invention contain CuO to thereby provide an operation to lower metamerism of the glass as well as to suppress the production of NiS. The metamerism is an index indicating the degree of a color change of a color tone or an outer color (a color observed from outside) due to color of outside light (color of outside light to be emitted) and can be defined by using the L*a*b* color system standardized by CIE (Commission Internationale de l'Éclairage). The lower the metamerism is, the smaller the degree of the color change of the color tone or the outer color due to the color of the outside light becomes. When the metamerism of the glass is high, if the kind of the light source is different, the visual effect of the color tone of the glass becomes greatly different. For example, the color tone of the glass indoors and the color tone of the glass outdoors differ greatly.

Further, by containing the Cu component, the glass for chemical strengthening and the chemical strengthened glass of the present invention can be made to have both of an absolute value of Δa* defined by the following expression (1) and an absolute value of Δb* defined by the following expression (2) of 2.0 or less. This can reduce the difference between a reflected color tone of the glass indoors and a reflected color tone of the glass outdoors.

Δa* represents a difference between chromaticity a* of reflected light by a D65 light source and chromaticity a* of reflected light by an F2 light source in the L*a*b* color system.

Δa*=a*value(D65 light source)−a*value(F2 light source) (1)

Δb* represents a difference between chromaticity b* of the reflected light by the D65 light source and chromaticity b* of the reflected light by the F2 light source in the L*a*b* color system.

Δb*=b*value(D65 light source)−b*value(F2 light source) (2)

Note that the glass before chemical strengthening and having metamerism suppressed exhibits the similar tendency (suppressed metamerism) also after the chemical strengthening.

In the L*a*b* color system, a* indicates a color tone change from red to green, and b* indicates a color tone change from yellow to blue. What color tone change human being more sensitively feels is a color tone change from red to green. The glass for chemical strengthening and the chemical strengthened glass of the present invention can achieve the glass having metamerism suppressed by making both of absolute values of Δa* and Δb* to 2.0 or less.

The glass for chemical strengthening and the chemical strengthened glass of the present invention preferably have a brightness L* defined using the L*a*b* color system falling within a range of 20 to 90. More specifically, when the brightness L* falls within the aforementioned range, the brightness of the glass is in an intermediate region between “bright” and “dark” and is therefore a in range which is easily recognized with respect to the color change, for which the present invention is more effectively used. Note that when L* is less than 20, the glass exhibits a deep color so that the color tone change of the glass is difficult to recognize. On the other hand, when L* exceeds 90, the glass exhibits a light color so that the color tone change of the glass is difficult to recognize. L* is preferably 22 to 85, more preferably 23 to 80, and even more preferably 24 to 75. The aforementioned brightness L* is based on data obtained by measuring reflected light in the case of using an F2 light source and installing a white resin plate on the rear surface side of the glass.

By containing the Cu component, the glass for chemical strengthening and the chemical strengthened glass of the present invention have a small difference between a reflected color tone of the glass in the case of using the D65 light source and a reflected color tone of the glass in the case of using F2 light source. This is considered to be because the glass containing the Cu component has a characteristic of absorbing light of a wavelength having a peak in the spectral distribution of the F2 light source and thereby lessens the difference in spectral distribution due to the light source, resulting in a reduced difference in the reflected color tone of the glass.

The chemical strengthened glass of the present invention is a glass obtained by chemical strengthening.

As a method to increase strength of the glass, a method of forming a compressive stress layer on a glass surface is generally known. Representative methods to form the compressive stress layer on a glass surface are an air-cooling tempering method (physical tempering method) and a chemical strengthening method. The air-cooling tempering method (physical tempering method) is performed by rapidly cooling by air cooling or the like a glass plate surface heated to a temperature near a softening point. On the other hand, the chemical strengthening method is to replace alkali metal ions (typically, Li ions, Na ions) having a smaller ion radius existing on the glass plate surface with alkali ions (typically, Na ions or K ions for Li ions, or K ions for Na ions) having a larger ion radius by ion exchange at temperatures lower than or equal to a glass transition point.

For example, in general, the glass used for an exterior member of an electronic device is often used with a thickness of 2 mm or less. When the air-cooling tempering method is employed for such a thin glass plate, it is difficult to assure a temperature difference between the surface and the inside, and hence it is difficult to form the compressive stress layer. Thus, in the glass after being strengthened, the intended high strength characteristic cannot be obtained. Further, in the air-cooling tempering, due to variation in cooling temperature, there is a great concern that the flatness of the glass plate is impaired. The concern that the flatness is impaired is large in a thin glass plate in particular, and there is a possibility of impairing texture aimed by the present invention. From these points, it is preferred that the glass is strengthened by the latter chemical strengthening method.

The chemical strengthening can be performed by immersing a glass in a molten salt at 400° C. to 550° C. for about 1 hour to about 20 hours. The molten salt used for the chemical strengthening is not particularly limited as long as it contains potassium ions or sodium ions and, for example, a molten salt of potassium nitrate (KNO₃) is preferably used. Besides, a molten salt of sodium nitrate (NaNO₃), or a molten salt made by mixing potassium nitrate (KNO₃) and sodium nitrate (NaNO₃) may be used.

As for the chemical strengthened glass of the present invention, a glass having a high mechanical strength can be obtained by forming a surface compressive stress layer on a surface of the glass through chemical strengthening. It is preferable that the strengthening is performed so that the depth of the surface compressive stress layer (DOL) formed on the surface of the glass is 10 μm or more, 12 μm or more, 15 μm or more. In the case of using the glass for an exterior member, the surface of the glass may be highly possibly scratched to decrease the mechanical strength of the glass. Hence, increasing the DOL makes the chemical strengthened glass difficult to break even if its surface is scratched. On the other hand, to make the glass after being strengthened easy to cut, the DOL is preferably 70 μm or less.

It is preferred that the chemical strengthened glass of the present invention has been chemically strengthened so that the surface compressive stress (CS) formed on the glass surface is 300 MPa or more, 500 MPa or more, 700 MPa or more, 900 MPa or more. An increase in CS increases the mechanical strength of the chemical strengthened glass. On the other hand, when the CS is too high, it is possible that the central tension stress inside the glass becomes extremely high, and therefore the CS is preferably 1400 MPa or less, more preferably 1300 MPa or less.

It is preferred that the chemical strengthened glass of the present invention has a central tension stress (CT) at the center in a plate thickness of the glass of 10 MPa or more. The spontaneous breakage of the glass due to NiS occurs when the sum of the central tension stress inside the glass and the central tension stress accompanying the expansion of NiS exceeds the strength of the glass. Further, the central tension stress accompanying the expansion of NiS depends on the outside diameter of NiS and becomes larger as the grain diameter is larger. In the chemical strengthened glass of the present invention, the production of NiS can be suppressed and therefore the CT can be set to 10 MPa or more. Thus, a chemical strengthened glass having a high mechanical strength can be obtained. The CT is preferably 20 MPa or more, more preferably 30 MPa or more. On the other hand, when the CT becomes extremely high, the risk that the glass spontaneously breaks due to the existence of NiS with a small grain diameter increases, and therefore the CT is preferably 80 MPa or less.

It is preferred that the glass for chemical strengthening and the chemical strengthened glass of the present invention are used as an exterior member. Since the production of NiS is suppressed and the metamerism is suppressed in the glass, a high mechanical strength and beauty can be given to a device using the exterior member. Besides, when the chemical strengthened glass is applied as the exterior member, a high mechanical strength which prevents breakage and scratch due to impact can be provided. The exterior member is to be provided, for example, on the outer surface of an electronic device, but is not limited to the electronic device and may be provided on the outer surface of decorations, building material, furniture, automobile control panel and interior part. Further, the glass itself may be constitute an article. Further, the shape of the glass is not limited to a flat plate shape, the glass may have a shape other than the flat plate shape.

As the exterior member, not particularly limited, the glass can be preferably used for a mobile electronic device that is presumed to be used indoors and outdoors. The mobile electronic device means a concept including a communication device and an information device for mobile use. Examples of the communication device include a mobile phone, a PHS (Personal Handy-phone System), a smartphone, a PDA (Personal Data Assistance), a PND (Portable Navigation Device, a portable car navigation system) as a communication terminal, and include a portable radio, a portable television set, a One-Seg receiver as a broadcast receiver. Further, examples of the information devices include a digital camera, a video camera, a portable music player, a sound recorder, a portable DVD player, a portable game machine, a laptop personal computer, a tablet PC, an electronic dictionary, an electronic notebook, an electronic book reader, a portable printer, a portable scanner, and so on. Further, the exterior member is also usable for a stationary-type electronic device and an electronic device internally mounted on an automobile. Note that the exterior member is not limited to these examples.

The method for manufacturing the glass of the present invention is not particularly limited. For example, appropriate amounts of various glass materials are blended, heated and melted, thereafter made uniform by bubble elimination, stirring, or the like, and formed in a plate shape or the like by a known down-draw method, press method, or the like, or casted and formed in a desired shape. Then, the glass is cut into a desired size after slow cooling, and polishing as necessary. Alternatively, the glass once molded into a block shape is reheated and thereby softened, then press-formed into a glass in a desired shape. Further, the chemical strengthened glass of the present invention is made by chemical strengthening the thus-obtained glass. Then, the glass subjected to chemical strengthening is cooled to form into the chemical strengthened glass.

In the foregoing, the examples of the glass for chemical strengthening and the chemical strengthened glass of the present invention have been described, but the structure can be appropriately changed as necessary within a limit that does not go against the spirit of the present invention.

### Examples

Hereinafter, the present invention will be described in detail on the basis of examples of the present invention and comparative examples, but the invention is not limited only to them.

Regarding Example 1 to Example 20 of Tables 1 to 2 (Example 1 to Example 3, Example 7 to Example 20 are examples of the present invention, and Example 4 and Example 6 are comparative examples), generally used glass materials such as oxides, hydroxides, carbonates, nitrate salts, and the like were selected appropriately and measured to be 100 ml as a glass so that they are in compositions expressed in mole percent in the tables. Note that SO₃ described in the tables is residual SO₃ remaining in the glass after sodium sulfate (Na₂SO₄) is added to the glass materials and after the sodium sulfate is decomposed, and is a calculated value.

Next, this material mixture was put into a melting pot made of platinum, and the glass was melted at a melting temperature of 1400° C., and after it was confirmed that the glass was melted down, the glass was bubble-eliminated at a fining temperature of 1550° C. Thereafter, it was poured into a mold material, which is about 50 mm long, about 100 mm wide, and about 20 mm high, and slowly cooled at the rate of about 1° C./min, thereby obtaining a glass block.

TABLE 1

| | | | | | | | | | | | Example |
|---|---|---|---|---|---|---|---|---|---|---|---|
| | mol % | Example 1 | Example 2 | Example 3 | Example 4 | Example 5 | Example 6 | Example 7 | Example 8 | Example 9 | 10 |
| | SiO₂ | 63.6 | 62.6 | 63.4 | 63.8 | 65.3 | 63.7 | 70.4 | 71.2 | 70.9 | 70.9 |
| | B₂O₃ | 0 | 0 | 0 | 0 | 0 | 0 | 0 | 0 | 0 | 0 |
| | Al₂O₃ | 7.9 | 7.8 | 7.9 | 7.9 | 7.9 | 7.9 | 3.1 | 3.1 | 5.1 | 8.1 |
| | Na₂O | 12.8 | 12.1 | 12.4 | 12.4 | 13.9 | 12.4 | 16.5 | 16.6 | 14.6 | 14.6 |
| | K₂O | 4 | 3.9 | 3.9 | 4 | 4 | 3.9 | 0.2 | 0.2 | 0.2 | 0.2 |
| | MgO | 9.3 | 10.2 | 10.4 | 10.4 | 7.4 | 10.4 | 8.4 | 8.5 | 8.5 | 5.5 |
| | ZrO₂ | 0.4 | 0.4 | 0.4 | 0.4 | 0.4 | 0.5 | 0 | 0 | 0 | 0 |
| | CaO | 0 | 0 | 0 | 0 | 0 | 0 | 0 | 0 | 0 | 0 |
| | CuO | 1 | 2 | 0.5 | 0 | 0 | 0 | 0.7 | 0.13 | 0.4 | 0.3 |
| | NiO | 0.7 | 0.6 | 0.6 | 1 | 0.7 | 0.5 | 0.6 | 0.14 | 0.28 | 0.13 |
| | Co₃O₄ | 0.4 | 0 | 0.05 | 0 | 0.05 | 0.06 | 0.007 | 0.0018 | 0.003 | 0.006 |
| | TiO₂ | 0 | 0.25 | 0.25 | 0 | 0.25 | 0.5 | 0 | 0 | 0 | 0 |
| | Fe₂O₃ | 0 | 0 | 0 | 0 | 0 | 0 | 0 | 0 | 0 | 0 |
| | Er₂O₃ | 0 | 0 | 0 | 0 | 0 | 0 | 0 | 0 | 0 | 0 |
| | MnO₂ | 0 | 0 | 0 | 0 | 0 | 0 | 0 | 0 | 0 | 0 |
| | SO₃ | 0.1 | 0.1 | 0.1 | 0.1 | 0.1 | 0.1 | 0.1 | 0.1 | 0.1 | 0.1 |
| | Total | 100.2 | 99.95 | 99.9 | 100 | 100 | 99.96 | 100.01 | 99.97 | 100.08 | 99.84 |
| | amount | | | | | | | | | | |
| F2 light | L* | 26.33 | 33.04 | 26.51 | 31.12 | 25.08 | 28.18 | 32.90 | 60.79 | 42.33 | 56.70 |
| source | a* | −0.09 | −2.53 | −0.40 | 5.66 | 2.85 | 0.55 | −0.23 | 0.35 | −0.34 | −0.22 |
| | b* | −3.29 | 10.82 | −2.81 | 9.77 | −10.46 | −9.71 | −1.43 | 0.54 | 1.73 | −3.36 |
| D65 | L* | 26.32 | 32.42 | 26.47 | 30.39 | 25.26 | 28.30 | 32.65 | 60.39 | 41.77 | 56.4 |
| light | a* | 0.82 | −3.57 | 0.92 | 9.18 | 5.59 | 3.11 | 0.82 | 1.13 | 0.63 | 1.43 |
| source | b* | −3.32 | 9.53 | −3.02 | 8.37 | −10.03 | −9.14 | −1.82 | 1.06 | 1.40 | −2.41 |
| D65 − | Δa* | 0.91 | −1.04 | 1.32 | 3.52 | 2.74 | 2.56 | 1.05 | 0.78 | 0.97 | 1.65 |
| F2 | Δb* | −0.03 | −1.29 | −0.21 | −1.40 | 0.43 | 0.57 | −0.39 | 0.52 | −0.33 | 0.95 |

TABLE 2

| | | Example | Example | Example | Example | Example | Example | Example | Example | Example | Example |
|---|---|---|---|---|---|---|---|---|---|---|---|
| | mol % | 11 | 12 | 13 | 14 | 15 | 16 | 17 | 18 | 19 | 20 |
| | SiO₂ | 71.2 | 64.1 | 71.3 | 71.1 | 69.4 | 70.8 | 70.9 | 64.0 | 72.3 | 71.3 |
| | B₂O₃ | 0 | 5.1 | 0 | 0 | 0 | 0 | 0 | 5.1 | 0 | 0 |
| | Al₂O₃ | 3.1 | 14.3 | 4.1 | 4.1 | 4.1 | 5.1 | 5.1 | 14.3 | 3.1 | 4.1 |
| | Na₂O | 16.6 | 13.9 | 15.7 | 15.4 | 13.5 | 14.6 | 14.6 | 13.9 | 15.7 | 15.7 |
| | K₂O | 0.2 | 0 | 0.2 | 0.2 | 0.2 | 0.2 | 0.2 | 0 | 0.2 | 0.2 |
| | MgO | 8.5 | 2.3 | 8.5 | 5.4 | 11.4 | 8.5 | 8.5 | 2.3 | 8.5 | 8.5 |
| | ZrO₂ | 0 | 0 | 0 | 0 | 0 | 0 | 0 | 0 | 0 | 0 |
| | CaO | 0 | 0 | 0 | 2.6 | 0 | 0 | 0 | 0 | 0 | 0 |
| | CuO | 0.13 | 0.13 | 0.04 | 0.74 | 0.74 | 0.37 | 0.35 | 0.13 | 0.02 | 0.04 |
| | NiO | 0.14 | 0.14 | 0.07 | 0.35 | 0.55 | 0.17 | 0.07 | 0.14 | 0.04 | 0.07 |
| | Co₃O₄ | 0.0008 | 0.007 | 0.002 | 0.021 | 0.012 | 0.003 | 0.003 | 0.002 | 0.003 | 0.003 |
| | TiO₂ | 0 | 0 | 0 | 0 | 0 | 0 | 0 | 0 | 0 | 0 |
| | Fe₂O₃ | 0 | 0 | 0 | 0 | 0 | 0.20 | 0.15 | 0 | 0 | 0 |
| | Er₂O₃ | 0 | 0 | 0 | 0 | 0 | 0 | 0 | 0 | 0 | 0 |
| | MnO₂ | 0 | 0 | 0 | 0 | 0 | 0 | 0 | 0 | 0 | 0 |
| | SO₃ | 0.1 | 0.1 | 0.1 | 0.1 | 0.1 | 0.1 | 0.1 | 0.1 | 0.1 | 0.1 |
| | Total | 99.97 | 100.08 | 100.01 | 100.00 | 100.00 | 100.00 | 100.00 | 100.00 | 100.00 | 100.00 |
| | amount | | | | | | | | | | |
| F2 light | L* | 62.23 | 66.42 | 73.34 | 38.30 | 35.77 | 53.83 | 66.99 | 71.87 | 73.06 | 82.48 |
| source | a* | 0.63 | −1.38 | 0.10 | −2.80 | −2.51 | −0.42 | −3.90 | 1.03 | −1.12 | −0.26 |
| | b* | 2.70 | 10.25 | −4.00 | −15.34 | 7.32 | 8.54 | −1.56 | 18.56 | −13.10 | −3.49 |
| D65 | L* | 61.72 | 65.75 | 73.29 | 38.98 | 35.21 | 53.09 | 67.02 | 70.84 | 73.60 | 82.54 |
| light | a* | 1.38 | −0.43 | 0.72 | −2.39 | −2.20 | 0.54 | −4.69 | 2.18 | −0.64 | −0.16 |
| source | b* | 2.97 | 9.37 | −2.78 | −13.36 | 6.06 | 7.91 | −0.70 | 16.72 | −10.87 | −2.36 |
| D65 − | Δa* | 0.75 | 0.95 | 0.62 | 0.41 | 0.31 | 0.96 | −0.79 | 1.15 | 0.48 | 0.10 |
| F2 | Δb* | 0.27 | −0.88 | 1.22 | 1.98 | −1.26 | −0.63 | 0.86 | −1.84 | 2.23 | 1.13 |

This glass block was cut, and after the glass was cut out to have a size of 40 mm×40 mm and a desired thickness, it was grinded and finally mirror polished on both surfaces, thereby obtaining a plate-shaped glass for chemical strengthening. The thickness of the cut out glass was 0.8 mm in Example 1 to Example 7, Example 15, 1.2 mm in Examples 8 to 13, Example 16 to Example 19, 0.723 mm in Example 14, and 0.6 mm in Example 20.

The glass for chemical strengthening of Example 1 was subjected to chemical strengthening and then soak treatment (hereinafter, referred to as a heat soak test). As the condition of the chemical strengthening, the glass was immersed for 10 hours in a molten salt made of KNO₃ (99%) and NaNO₃ (1%) at 450° C. In the glass after the chemical strengthening, the surface compressive stress (CS) was 728 MPa, the depth of the surface compressive stress layer (DOL) was 56 μm, and the central tension stress (CT) at the center of a plate thickness was 59 MPa. The glass for chemical strengthening of Example 8 was immersed for 2 hours in a molten salt made of KNO₃ (99%) and NaNO₃ (1%) at 400° C. In the glass after the chemical strengthening, the surface compressive stress (CS) was 706 MPa, the depth of the surface compressive stress layer (DOL) was 15 μm. Note that the above measurement was carried out using a surface stress measurement apparatus. This apparatus is an apparatus utilizing the fact that the surface compressive stress layer formed on a glass surface differs in refractive index from other glass portions in which the surface compressive stress layer does not exist, thereby exhibiting an optical waveguide effect. Further, in the surface stress measurement apparatus, an LED whose central wavelength is 795 nm was used as a light source to perform the measurement.

As the condition of the heat soak test, the rate of heating of the glass from room temperature to a retention temperature is 1.8° C./min, the retention temperature of the glass is 250° C. to 255° C., the time period of retaining the retention temperature is 55 minutes. When 10000 sheets of the chemical strengthened glass of Example 1 were prepared and subjected to the above-described heat soak test, there was no glass that broke due to NiS. Accordingly, the glass of the present invention is considered to be able to suppress the production of NiS with high probability.

Then, for the plate-shaped glass for chemical strengthening obtained, the color tone before the chemical strengthening was measured.

As the color tone of each glass, the chromaticity of reflected light in the L*a*b* color system standardized by CIE was measured. Using an F2 light source and a D65 light source as the light source, the chromaticity of the reflected light was measured for each of them. The chromaticity measurement of the reflected light in the L*a*b* color system was performed using the spectro-colorimeter (Colori7 made by X-Rite, Inc.). Note that on a rear face side (the rear face of a face irradiated with light from the light source) of the glass, a white resin plate was placed to perform measurement. Measurement results are illustrated in Table 1 and Table 2.

As illustrated in Table 1 and Table 2, in each of the glasses of the examples of the present invention containing CuO at a fixed amount or more (for example, 0.03% or more), both of Δa* and Δb* which are the indexes of the metamerism are 2.0 or less, from which it can be seen that the metamerism can be suppressed. In contrast, the glasses of the comparative examples containing no CuO but containing NiO, Δa* exceeds 2.0, from which it can be seen that the metamerism cannot be suppressed.

Besides, the glasses for chemical strengthening of Example 8 to Example 10 were immersed for 6 hours in a molten salt made of KNO₃ (99%) and NaNO₃ (1%) to be chemically strengthened for manufacture of chemical strengthened glasses. Here, the glass was treated using a molten salt at 425° C. in Example 8, and the glasses were treated using a molten salt at 450° C. in Examples 9, 10. For the color tone of the chemical strengthened glass after the chemical strengthening, the chromaticity of the reflected light in the L*a*b* color system standardized by CIE was measured by the method similar to the above. Measurement results are illustrated in Table 3.

TABLE 3

| | | Example 8 | Example 9 | Example 10 |
|---|---|---|---|---|
| F2 light | L* | 59.49 | 42.18 | 56.6 |
| source | a* | 0.93 | −0.18 | −0.20 |
| | b* | −2.47 | 0.98 | −3.72 |
| D65 light | L* | 59.21 | 41.65 | 56.32 |
| source | a* | 1.89 | 0.82 | 1.42 |
| | b* | −1.65 | 0.73 | −2.73 |
| D65 − F2 | Δa* | 0.96 | 1.00 | 1.62 |
| | Δb* | 0.82 | −0.25 | 0.99 |

As illustrated in Table 3, in the glass containing CuO after the chemical strengthening, both of Δa* and Δb* which are the indexes of the metamerism are kept at 2.0 or less, from which it can be seen that the metamerism can be suppressed.

The present invention can be used for decorations of an operating panel of an audiovisual apparatus, office automation apparatus, or the like, an opening/closing door, an operating button/knob of the same product, or the like, or a decorative panel disposed around a rectangular display surface of an image display panel of a digital photo frame, TV, or the like, and for a glass exterior member for an electronic device, and the like. It can also be used for an automobile interior member, a member of furniture or the like, a building material used outdoors or indoors, or the like.

What is claimed is:

1. A glass for chemical strengthening comprising, in mole percentage based on following oxides, 55% to 80% of SiO₂, 3% to 16% of Al₂O₃, 0% to 12% of B₂O₃, 5% to 20% of Na₂O, 0% to 15% of K₂O, 0% to 15% of MgO, 0% to 3% of CaO, 0% to 18% of ΣRO (R represents Mg, Ca, Sr, Ba, Zn), 0.005% to 1% of SO₃, 0.001% to 3% of NiO, and 0.001% to 3% of CuO.

2. The glass for chemical strengthening according to claim 1, wherein the glass contains 0.005% to 1% of SO₃, 0.01% to 3% of NiO, and 0.01% to 3% of CuO.

3. The glass for chemical strengthening according to claim 1, wherein both of an absolute value of a difference Δa* between chromaticity a* of reflected light by a D65 light source and chromaticity a* of reflected light by an F2 light source in an L*a*b* color system expressed by a following expression (1) and an absolute value of a difference Δb* between chromaticity b* of the reflected light by the D65 light source and chromaticity b* of the reflected light by the F2 light source in the L*a*b* color system expressed by a following expression (2), are 2.0 or less.
Δa*=a*value(D65 light source)−a*value(F2 light source) (1)
Δb*=b*value(D65 light source)−b*value(F2 light source) (2)

4. A chemical strengthened glass comprising: in mole percentage based on following oxides, 55% to 80% of SiO₂, 3% to 16% of Al₂O₃, 0% to 12% of B₂O₃, 5% to 20% of Na₂O, 0% to 15% of K₂O, 0% to 15% of MgO, 0% to 3% of CaO, 0% to 18% of ΣRO (R represents Mg, Ca, Sr, Ba, Zn), 0.005% to 1% of SO₃, 0.001% to 3% of NiO, and 0.001% to 3% of CuO; and a surface compressive stress layer of 10 μm to 70 μm in a depth direction from a surface.

5. The chemical strengthened glass according to claim 4, wherein the chemical strengthened glass contains 0.005% to 1% of SO₃, 0.01% to 3% of NiO, and 0.01% to 3% of CuO.

6. The chemical strengthened glass according to claim 4, wherein both of an absolute value of a difference Δa* between chromaticity a* of reflected light by a D65 light source and chromaticity a* of reflected light by an F2 light source in an L*a*b* color system expressed by a following expression (1) and an absolute value of a difference Δb* between chromaticity b* of the reflected light by the D65 light source and chromaticity b* of the reflected light by the F2 light source in the L*a*b* color system expressed by a following expression (2), are 2.0 or less.
Δa*=a*value(D65 light source)−a*value(F2 light source) (1)
Δb*=b*value(D65 light source)−b*value(F2 light source) (2)

7. The chemical strengthened glass according to claim 4, having a surface compressive stress of 300 MPa to 1400 MPa.

8. The chemical strengthened glass according to claim 4, wherein a central tension stress (CT) at a center in a plate thickness direction is 10 MPa or more.

9. The chemical strengthened glass according to claim 4, used as an exterior member.
